(19) United States
(12) Patent Application Publication
(10) Pub. No.: US 2010/0316764 A1
(43) Pub. Date: Dec. 16, 2010

(54) FLOUR SUPPLEMENT COMPOSITIONS AND METHODS FOR PREPARING WHEAT FLOUR

(75) Inventors: Vaughn Studer, Manhattan, KS (US); Kendall McFall, Manhattan, KS (US)

Correspondence Address: Patent Docket Department;Armstrong Teasdale LLP, 7700 Forsyth Boulevard, Suite 1800, St. Louis, MO, 63105, US

(73) Assignee: Engrain, LLC, Manhattan, KS (US)

(21) Appl. No.: 12/796,076

(22) Filed: Jun. 8, 2010

Related U.S. Application Data
(60) Provisional application No. 61/185,713, filed on Jun. 10, 2009.

(51) Int. Cl. A21D 13/06; A21D 2/08; A21D 8/04

(52) U.S. Cl. 426/20; 426/61; 426/559

(57) ABSTRACT

The present disclosure is directed to flour supplement compositions that contain transglutaminase and an amino acid selected from lysine, glutamine or a combination thereof. Additionally, the present disclosure is directed to flour-based food compositions or foodstuffs (e.g., breads, pastas, noodles, etc.) prepared with the supplement. The present disclosure is still further directed to methods for preparing wheat flour compositions by adding the supplement or alternatively by adding an amino acid selected from lysine, glutamine or a combination thereof and transglutaminase to flour used therein.

### CROSS-REFERENCE TO RELATED APPLICATION

This application claims the benefit of U.S. Provisional Application No. 61/185,713, filed Jun. 10, 2009, which is incorporated herein for all relevant and consistent purposes.

### BACKGROUND

The field of the disclosure relates to flour supplement compositions and, particularly, compositions that contain an amino acid and transglutaminase. Further aspects of the disclosure include various flour-based compositions and flour-based foodstuffs (e.g., breads, pastas, etc.), methods for preparing flour-based compositions, and methods for preparing flour-based foodstuffs (e.g., bread, pasta, noodles, etc.).

Conventional methods for preparing leavened, flour-based foodstuffs like bread and pasta often utilize flour with a high protein content. When low-protein flours are used in bread, the bread must generally be kneaded longer and the resulting loaves have a smaller volume relative to loaves prepared with high-protein flour. To overcome the disadvantages attendant use of low-protein flours, protein supplements such as vital wheat gluten may be added. However, utilization of vital wheat gluten in bread production is limited due to, for example, its relatively high cost.

Pasta noodles have conventionally been prepared from high-protein flours and, particularly, from durum wheat flour. Flours with a low protein content are not typically used in pasta noodles, as the noodles are characterized by poor water-absorption and undesirable texture.

Accordingly, a need exists for methods and supplement compositions that allow low-protein flours to be utilized in the preparation of various flour-based foodstuffs, including bread and pasta noodles.

### SUMMARY

One aspect of the disclosure is directed to a method for preparing a wheat flour composition. The method includes grinding wheat kernels to produce fragmented wheat particles. Flour is separated from larger wheat particles. Transglutaminase and an amino acid selected from the group consisting of lysine, glutamine and a combination thereof are added to the flour to produce a wheat flour composition.

Another aspect of the present disclosure is directed to a supplement composition that may be added to flour to enhance a property of a resulting flour-based product. The composition includes an amino acid selected from the group consisting of lysine, glutamine and a combination thereof and transglutaminase.

A further aspect includes a method for producing a bread product. The method includes mixing flour, transglutaminase, an amino acid selected from the group consisting of lysine, glutamine and a combination thereof, a leavening agent and water to make a dough. The dough is leavened to produce a bread product.

In one aspect, a method for producing a noodle product includes mixing flour, transglutaminase, an amino acid selected from the group consisting of lysine, glutamine, and a combination thereof and water to make a dough. The dough is shaped into a noodle product.

In another aspect of the present disclosure, a bread contains less than about 10% by weight protein and has a volume to weight ratio of at least about 9:2.

In one aspect, a bread contains less than about 10% by weight protein and has a volume at least the volume that could be achieved by producing a bread product under substantially the same production conditions from a dough comprising flour with at least a 10.5% by weight protein content with no transglutaminase or lysine added thereto.

In a further aspect, a bread contains less than about 10% by weight protein and less than about 5% by weight vital wheat gluten and has a volume at least the volume that could be achieved by producing a bread product under substantially the same production conditions from a dough comprising flour with at least about 5% by weight vital wheat gluten with no transglutaminase or lysine added thereto.

One aspect of the present disclosure is directed to a flour composition that includes flour, at least about 25 ppm amino acid selected from the group consisting of lysine, glutamine and a combination thereof and at least about 1 ppm transglutaminase.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a schematic flow-diagram of a flour mill according to one embodiment of the present disclosure; and

FIG. 2 is a schematic flow-diagram of flour-blending and finished flour product loadout operations with transglutaminase and amino acid addition.

Corresponding reference characters indicate corresponding parts throughout the drawings.

### DETAILED DESCRIPTION

One embodiment of the present disclosure is directed to a method for preparing a wheat flour composition. Generally, the method includes preparing flour from wheat kernels and adding transglutaminase and an amino acid and, more particularly, an amino acid selected from lysine, glutamine and combinations thereof to the flour. Without being bound to any particular theory, it is generally believed that transglutaminase enzyme acts to link lysine and/or glutamine to lysine or glutamine already present in protein within the flour. This results in the formation of cross-links between protein polymer chains. Cross-linking of the protein polymer chains is believed to cause the protein to strengthen. As a result, foodstuffs or food products prepared using flour that contains transglutaminase and lysine and/or glutamine, such as bread loaves, are less dense and proportionally larger, as compared to similar products produced from flour that does not contain these components. The combination of transglutaminase and an amino acid is believed to be especially advantageous when used with low-protein flour, as low-protein flour typically yields small volume (or more dense) bread loaves or other food products.

Advantageously, it has also been discovered that transglutaminase and an amino acid (e.g., lysine and/or glutamine) may be added in a flour mill after the majority of sifting and particle size reduction steps have been performed to prepare the flour. This allows the transglutaminase and the amino acid to be added to particular finished flours, rather than all finished products in general. When the transglutaminase and the amino acid are added upstream, for instance during milling or during wheat tempering, the transglutaminase and the amino acid are distributed in many products of the wheat mill, including products in which a higher volume (or less dense) product is desired (products other than, for example, bread or pasta). Generally, it has been found that transglutaminase and the amino acid may be added prior to loadout; that is, the transglutaminase and the amino acid may be added prior to the loadout sifters of the milling process, which remove certain wheat particles and contaminants prior to loadout of product. By mixing the transglutaminase and the amino acid at this point of the process, the transglutaminase and the amino acid are added only to the targeted finished flour products and are sufficiently mixed throughout the flour.

Another provision of the present disclosure includes supplement compositions that include an amino acid selected from lysine, glutamine or a combination thereof and transglutaminase. Such compositions may be utilized for adding transglutaminase and the amino acid to flour at, for example, flour mills, bread bakeries and pasta production facilities. Other provisions include various flours and flour-based foodstuffs including breads and methods for producing bread, flour and noodle products.

### Methods for Preparing Wheat Flour Compositions

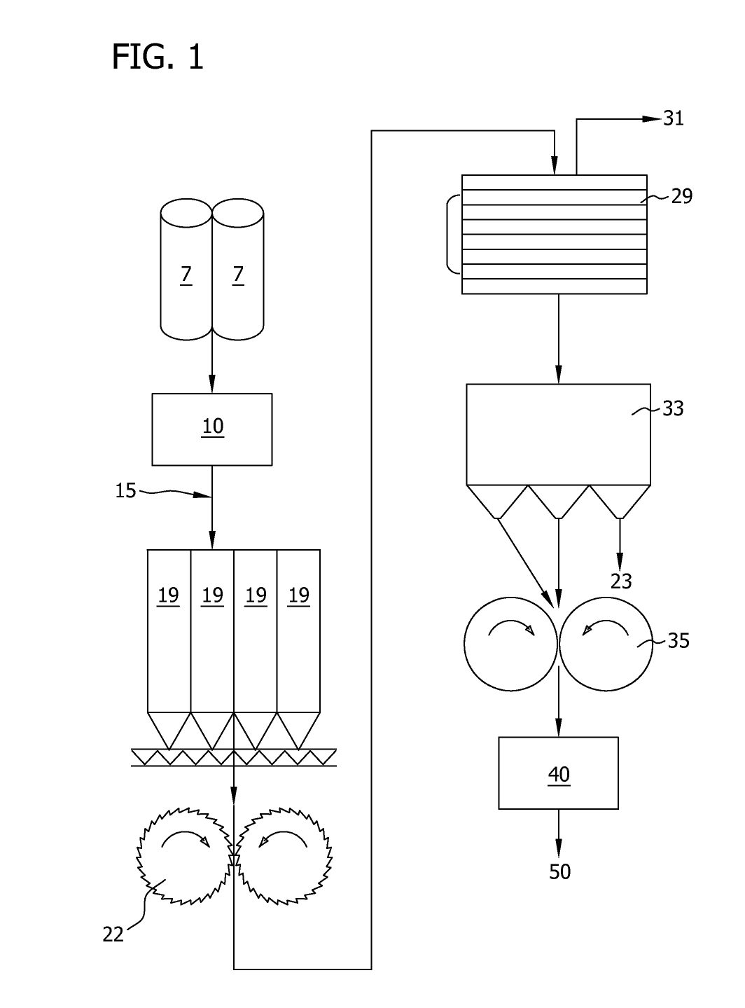

In one aspect of the present disclosure, a method for preparing a wheat flour composition includes grinding wheat kernels to produce fragmented wheat particles, separating flour from larger wheat particles and adding transglutaminase and an amino acid selected from lysine, glutamine and a combination thereof to the flour to produce a wheat flour composition. Referring now to FIG. 1, a schematic of a simplified process for producing wheat flour and, particularly, typically equipment utilized in a wheat mill is shown. Wheat kernels (or simply “wheat”) are stored in wheat bulk storage units 7. The wheat undergoes pre-treatment 10. Pre-treatment 10 may include, for example, removal of debris and other impurities such as sticks, stones, barley, oats, red dog and the like. Equipment that may be utilized to remove the debris and impurities includes reciprocating screens, aspirators, disc separators and magnetic separators. Roughage and impurities may also be scoured off of the wheat kernels in a scourer during pre-treatment 10.

After pre-treatment 10, water 15 is added to the pre-treated wheat and the moistened wheat is stored in tempering bins 19. In various embodiments, water in an amount from about 2% to about 10% by weight of the wheat may be added to the wheat for tempering. The water 15 is free of transglutaminase and lysine and may be free of glutamine as well. Generally, the moistened wheat is stored in the tempering bins 19 for at least about 12 hours with periods between about 24 and about 48 hours being typical. The tempered wheat is then introduced into a size-reduction unit 22. The size-reduction unit 22 may include rollers or “rolls” that are corrugated and rotate in opposite directions. As the wheat passes through the rolls 22 it is broken into fragmented particles that may contain bran, the flour-containing endosperm and/or germ. The initial sets of rolls are conventionally known as the “break rolls.”

After the size reduction unit 22, the fragmented particles may be introduced into a sifter 29. In the sifters, the particles are shaken through a series of bolting cloths or screens to separate the larger particles from the smaller particles. The particles may be separated according to several size classifications. Each size classification may undergo purification and further size reduction through reducing rolls. Each sifter 29 in the process generally produces an amount of flour that may be a commercial product itself or combined with another source of flour in the mill to form a flour product. Much of the bran and shorts (i.e., a blend of fine wheat bran particles, germ and a portion of endosperm) shakes off the top of the sifter 29 (particularly the first sifter) and may be recovered as an animal food product 31.

A portion of the separated particles from the sifter 29 may be introduced into a purifier 33. In one embodiment, the purifier 33 uses air to lift off and separate bran particles from the material introduced into the purifier. The purifier 33 may include a sieve cloth that separates and grades material fractions by size and quality.

The coarse fractions from the purifier 33 may be introduced into a reducing roll 35. The further fragmented particles may be introduced to a finishing system 40. The finishing system 40 may include further sifters, purifiers and reducing rolls. Generally, the finishing system 40 produces finished flour 50 such as, for example, patent flour or clear flour and by-products such as bran, shorts and germ. Depending on the desired products, the flour may also be bleached in the finishing system 40 by the use of benzoyl peroxide or chlorine gas.

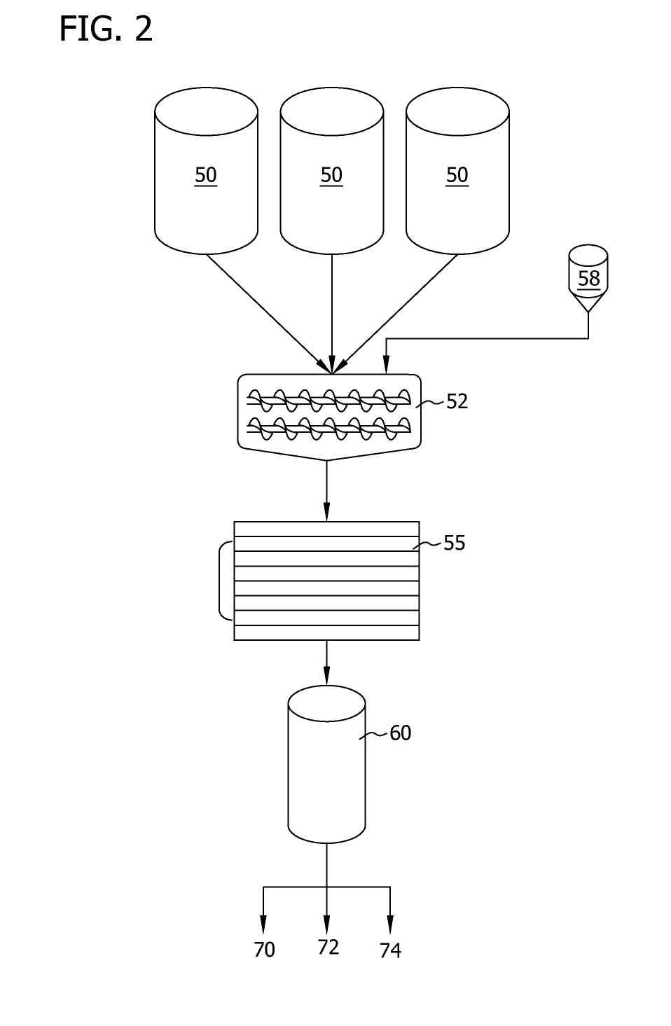

Referring now to FIG. 2, finished flour from the mill may be stored in bulk storage 50. The flours may be blended to form a finished flour product before loadout. The flours may be combined in a mixer 52. The flours may be added continually to the mixer 52 with the respective rates of addition of each flour composition being controlled and metered or a batch process may be utilized wherein each flour composition is weighed out and added to the mixer. Batch processes are suitable for relatively smaller loadout systems. In one embodiment, flour is added to the mixer 52 in a continuous-batch system where each flour composition is weighed out in separate hoppers or in the mixer itself. More than one mixer 52 is utilized to ensure constant flow of material.

Before loadout and after any blending in the mixer 52 the flour composition may be sent through a loadout sifter 55 to remove any contaminants to ensure the flour shipped to the customer is free of foreign matter and other impurities. Finished products may be stored in loadout storage 60. Finished flour products may be transported by a bulk delivery unit such as a bag 70, railcar 72 and/or truck 74.

Transglutaminase and the amino acid selected from lysine, glutamine and a combination thereof may be added to a finished flour to produce supplemented flour products by adding the compounds to the mixer 52. Transglutaminase and the amino acid may be stored together as a single supplement in additive storage 58 and metered in continually, continually-batchwise or batchwise. In one embodiment, transglutaminase and the amino acid are stored separately and added to the mixer 52 separately.

In one embodiment, transglutaminase and the amino acid are particulates. The particle sizes of the transglutaminase and the amino acid should be sufficiently small to allow them to pass through the loadout sifter 55, i.e., the average nominal diameter of the amino acid and transglutaminase should be less than the screen size of the sifter. In some embodiments, particles less than about 125 μm pass through the sifter. In another embodiment, the transglutaminase and the amino acid are present in a solution and the solution is added to the mixer 52.

While transglutaminase and the amino acid are described as being added to the flour composition in the mixer 52, it should be understood that transglutaminase and the amino acid may be added elsewhere in the process without departing from the scope of the present disclosure. For example, transglutaminase and/or the amino acid may be added to bulk storage 50, upstream of bulk storage 50, after the mixer 52, after the sifter 55 or during loadout to bags 70, railcars 72 and/or truck 74. In various embodiments, the transglutaminase and the amino acid are added to a finished flour product (i.e., not before a final sifting operation) to prevent transglutaminase and/or the amino acid from ending up in an undesired flour product or by-product.

While the equipment shown in FIGS. 1 and 2 is described in the singular, it should be understood that multiple units (e.g., size-reduction units, sifters, purifiers and the like) may be utilized to produce flour without departing from the scope of the present disclosure. Further, each unit may be rearranged in the process, removed, substituted for and the like without departing from the scope of the present disclosure. Other unit operations (not shown) may also be included without departing from the scope of the present disclosure.

Generally, for purposes of the present disclosure, references to the phrase “amino acid,” refer to lysine, glutamine or the combination of lysine and glutamine. Further, for purposes of the present disclosure, unless stated otherwise, references to “amino acid,” “lysine” or “glutamine” and the amount of such components added or present in various compositions of the present disclosure refer to “free amino acid,” i.e., lysine or glutamine that has not been bound to the proteins within the flour composition and does not include lysine or glutamine present in the protein itself. Identification and determination of the type and concentration of a given free amino acid may be achieved by means generally known in the art.

In embodiments were lysine is added to the flour composition, lysine may be added in an amount or at a rate such that the resulting wheat flour composition comprises at least about 50 ppm lysine by weight. A suitable commercially available lysine composition is L-Lysine Monohydrochloride 98% available from Ajinomoto AminoScience LLC (Raleigh, N.C.). In one embodiment of the present disclosure, lysine is added until the wheat flour composition comprises at least about 100 ppm by weight lysine. In various other embodiments, lysine is added until the wheat flour composition includes from about 50 ppm to about 1000 ppm lysine by weight or from about 100 ppm to about 750 ppm lysine by weight.

In embodiments were glutamine is added to the flour composition, glutamine may be added in an amount or at a rate such that the resulting wheat flour composition comprises at least about 25 ppm glutamine by weight. In one embodiment of the present disclosure, glutamine is added until the wheat flour composition comprises at least about 50 ppm glutamine by weight. In various other embodiments, glutamine is added until the wheat flour composition includes from about 25 ppm to about 500 ppm glutamine by weight or from about 50 ppm to about 400 ppm glutamine by weight.

In one embodiment of the present disclosure, transglutaminase is added in an amount or at a rate such that the resulting wheat flour composition includes at least about 1 ppm transglutaminase by weight and, in other embodiments, at least about 15 ppm or even at least about 30 ppm transglutaminase by weight. A suitable commercially available transglutaminase is ACTIVA® TG, available from Ajinomoto Food Ingredients LLC (Chicago, Ill.). In various other embodiments, transglutaminase is added until the wheat flour composition includes from about 1 ppm to about 500 ppm transglutaminase by weight, from about 15 ppm to about 500 ppm transglutaminase by weight or from about 30 ppm to about 300 ppm transglutaminase by weight.

The mass ratio of lysine to transglutaminase added to the flour and present in the wheat flour composition may be at least about 1:1. In other embodiments, the mass ratio of lysine to transglutaminase added to the flour is at least about 2:1, at least about 3:1 or from about 1:1 to about 5:1. The mass ratio of glutamine to transglutaminase added to the flour and present in the wheat flour composition may be at least about 1:2. In other embodiments, the mass ratio of glutamine to transglutaminase added to the flour is at least about 1:1, at least about 2:1 or from about 1:2 to about 3:1. By adding lysine and/or glutamine in excess to transglutaminase, multiple parts of lysine and/or glutamine may be bound within the protein by one part transglutaminase.

It should be understood that transglutaminase and the amino acid may be added according to embodiments other than that shown in FIGS. 1 and 2. For instance, the amino acid and transglutaminase may be added to a discreet amount of flour at a bakery to produce the wheat flour composition. Water may be added prior to, concurrently or after addition of the amino acid and transglutaminase to produce a dough which may be utilized to prepare a foodstuff such as bread or a noodle product.

Transglutaminase and the amino acid selected from lysine, transglutaminase and a combination thereof may be added to flour compositions concurrently or may be added sequentially without departing from the scope of the present disclosure. Alternatively or in addition, transglutaminase and the amino acid may be added as particulate solids or may be dissolved in a solvent such as water and added to the flour (such as, for example, addition at a bakery during production of dough). Transglutaminase and the amino acid may be part of a particulate mix or may be dissolved in the same solution.

In one embodiment, the lysine added to the flour is particulate lysine and the average nominal diameter of the particulate lysine is less than about 250 μm. In other embodiments, the average nominal diameter of the particulate lysine is less than about 125 μm or from about 5 μm to about 125 μm. Commercially available forms of lysine may contain lysine particles that are too large to pass through the loadout sifter 55. Accordingly, particulate lysine may be ground to reduce the average nominal diameter of the particulate lysine before addition to the flour. In various embodiments, the transglutaminase added to the flour is particulate transglutaminase and the average nominal diameter of the particulate transglutaminase is less than about 250 μm, less than about 125 μm or from about 5 μm to about 125 μm.

In one embodiment, the glutamine added to the flour is particulate glutamine and the average nominal diameter of the particulate glutamine is less than about 250 μm. In other embodiments, the average nominal diameter of the particulate glutamine is less than about 125 μm or from about 5 μm to about 125 μm. Commercially available forms of glutamine may contain glutamine particles that pass through the loadout sifter 55 without mechanical size reduction.

Additionally, additives other than an amino acid and transglutaminase may also be added to the flour composition. For instance, an additive such as certain additional enzymes and/or oxidation compounds (e.g., food-grade acids) may be added to the flour composition.

Generally, transglutaminase and the amino acid selected from lysine, glutamine and a combination thereof enhance the quality of the flour by imparting greater strength in the flour without increasing the protein content. It has been found to be particularly advantageous to utilize lysine and transglutaminase in low-protein flour which often suffers from a lack of strength which causes the resulting bread products to be denser than products produced from high-protein flours. Generally, for purposes of the present disclosure “low-protein” flour includes flour compositions with less than about 10.5% by weight protein. In one embodiment of the present disclosure, the flour to which lysine and transglutaminase are added contains less than about 10% by weight protein. In other embodiments, it contains less than about 9.5% by weight protein, less than about 9% by weight protein or even less than about 8.5% by weight protein. In various embodiments, the flour may contain from about 5% to about 10% by weight protein, from about 7.5% to about 10% by weight protein or from about 5% to about 9.5% by weight protein.

Several varieties of wheat are known to produce low-protein flour and are not typically utilized to produce bread such as soft white winter wheat and soft red winter wheat. By addition of transglutaminase and lysine, flour derived from soft white winter wheat or soft red winter wheat may produce suitable bread and pasta products without addition of a secondary protein source such as vital wheat gluten. Further, other low-protein flours such as whole-grain flours and high-extraction flours may be utilized to produce high-quality bread and pasta when transglutaminase and lysine are added to the flour.

By adding transglutaminase and lysine to the flour compositions, the flour is more able to absorb water. While low-protein flours typically are not capable of absorbing more than about 54% water, compositions produced by adding lysine and transglutaminase may absorb at least about 56% by weight water and, in another embodiment, at least about 60% by weight water.

By adding transglutaminase, lysine and glutamine to the flour compositions, resulting noodle products are characterized by greater elasticity relative to products produced by adding lysine and transglutaminase alone.

Generally, bread products may be produced by mixing a flour composition produced by embodiments of the methods described above with water and a leaving agent to produce a dough. The dough may be leavened to produce a bread product. Noodle products may be produced by mixing a flour composition produced from the methods described above and water to produce a dough. The dough may then be shaped into a noodle product.

### Supplement Compositions

Transglutaminase and the amino acid selected from lysine, glutamine and a combination thereof may be present in a supplement composition that may be added to the flour to enhance a property of a resulting flour-based foodstuff such as, for example, the ability of dough to absorb water, bread density and toughness and/or noodle elasticity.

In one embodiment, transglutaminase and the amino acid are present in the supplement composition as particulates. The transglutaminase and the amino acid particulates may be packaged separately in the supplement or they may be mixed. The transglutaminase and the amino acid may also be dissolved in a solvent such as water and the solution packaged as a supplement.

The supplement composition may be added to flour in any manner depending on the intended use of the flour. The composition may be added as described above and shown in FIGS. 1 and 2. In small batch operations, the transglutaminase and the amino acid may be measured out and added to the flour.

In one embodiment, the supplement composition comprises at least about 20% by weight lysine, glutamine or a combination thereof and, in other embodiments, at least about 35% or even at least about 50% by weight lysine, glutamine or a combination thereof. In various other embodiments, the supplement composition includes from about 20% to about 70% by weight lysine, glutamine or a combination thereof or from about 35% to about 70% by weight lysine, glutamine or a combination thereof. The lysine and/or glutamine may be particulate and the average nominal diameter of the particulate lysine and/or glutamine may be less than about 250 μm and, in other embodiments is less than about 125 μm or is from about 5 μm to about 250 μm. In certain embodiments, the supplement does not contain any detectable or measurable amount of free glutamine, but rather only transglutaminase and lysine with the amount of lysine in the supplement being as described above. In certain other embodiments, the supplement does not contain any detectable or measurable amount of free lysine, but rather only transglutaminase and glutamine with the amount of glutamine in the supplement being as described above.

The supplement composition may contain at least about 1% by weight transglutaminase. In other embodiments, the composition contains at least about 5% by weight transglutaminase, at least about 10% by weight transglutaminase, from about 1% to about 45% or from about 5% to about 45% by weight transglutaminase. The transglutaminase may be particulate and the average nominal diameter of the particulate transglutaminase may be less than about 250 μm and, in other embodiments, is less than about 125 μm or from about 5 μm to about 250 μm.

The mass ratio of lysine to transglutaminase in the supplement composition may be at least about 1:1 and, in other embodiments, is at least about 2:1 or even at least about 3:1. In one embodiment, the mass ratio of lysine to transglutaminase in the composition is from about 1:1 to about 5:1. The mass ratio of glutamine to transglutaminase in the composition may be at least about 1:2. In other embodiments, the mass ratio of glutamine to transglutaminase in the composition is at least about 1:1, at least about 2:1 or from about 1:2 to about 3:1. The supplement composition may contain additives such as enzymes and oxidation compounds.

Transglutaminase, lysine and glutamine are commercially available in particulate forms. The composition may be prepared by mixing the transglutaminase and the amino acid together in the desired proportions. When particle sizes less than the commercially available lysine, glutamine and/or transglutaminase are desired, the particle size of the lysine, glutamine or transglutaminase may be reduced by, for example, a grinding operation. Suitable techniques for grinding transglutaminase, lysine and/or glutamine include passing the material through counter-rotating rollers spaced closely apart (e.g., roller mills), hammer milling and pin milling. In certain grinding methods, low temperatures are desired to avoid a spontaneous explosion.

### Flour Compositions

Flour compositions of embodiments of the present disclosure may generally be prepared according to embodiments of methods described above and/or by addition of the supplement compositions described above. In one embodiment, the flour composition includes flour, at least about 50 ppm lysine and at least about 1 ppm transglutaminase by weight. In other embodiments, the flour composition may contain at least about 100 ppm lysine by weight, from about 50 ppm to about 1000 ppm by weight or from about 100 ppm to about 750 ppm lysine by weight. The lysine may be a particulate with the average nominal diameter of the particulate lysine being less than about 250 μm by weight. In other embodiments, the average nominal diameter of the particulate lysine is less than about 125 μm by weight or from about 5 μm by weight to about 125 μm by weight.

Alternatively or in addition, the flour composition may include at least about 25 ppm glutamine and at least about 1 ppm transglutaminase by weight. In other embodiments, the flour composition may contain at least about 50 ppm glutamine by weight, from about 25 ppm to about 500 ppm or from about 50 ppm to about 400 ppm glutamine by weight. The glutamine may be a particulate with the average nominal diameter of the particulate glutamine being less than about 250 μm by weight. In other embodiments, the average nominal diameter of the particulate glutamine is less than about 125 μm by weight or from about 5 μm by weight to about 125 μm by weight.

The compositions may also contain various amounts of transglutaminase. In various embodiments, the flour composition may contain by weight at least about 15 ppm transglutaminase, at least about 30 ppm transglutaminase, from about 1 ppm to about 500 ppm transglutaminase, from about 15 ppm to about 500 ppm transglutaminase or from about 30 ppm to about 300 ppm transglutaminase. The transglutaminase may be particulate transglutaminase with the average nominal diameter of the particulate transglutaminase being less than about 250 μm. In other embodiments, the average nominal diameter of the particulate transglutaminase is less than about 125 μm or from about 5 μm to about 125 μm.

The ratio of lysine to transglutaminase added to the flour may be at least about 1:1. In other embodiments, the mass ratio of lysine to transglutaminase added to the flour is at least about 2:1, at least about 3:1 or from about 1:1 to about 5:1. The mass ratio of glutamine to transglutaminase added to the flour may be at least about 1:2. In other embodiments, the mass ratio of glutamine to transglutaminase added to the flour is at least about 1:1, at least about 2:1 or from about 1:2 to about 3:1. The flour composition may also contain an additive such as other enzymes or oxidation compounds.

Any flour may be included in the flour composition including low-protein flours. The flour may contain less than about 10% by weight protein, less than about 9.5% by weight protein, less than about 9% by weight protein, less than about 8.5% by weight protein, from about 5% to about 10% by weight protein, from about 7.5% to about 10% by weight protein or from about 5% to about 9.5% by weight protein. The flour may be a wheat flour including, for example, low-protein flours such as soft white winter wheat flour and soft red winter wheat flour. The flour may be a whole-grain flour or high-extraction flour.

While the flour composition is generally described as including wheat flour, other flours may be included with or substituted for wheat flour without departing from the scope of the present disclosure. For instance, the flour may include wheat flour and a cereal grain flour other than wheat flour. Suitable cereal grain flours include rice, corn, rye, tapioca flours and mixtures thereof. In one embodiment, the flour consists essentially of a flour derived from a cereal grain selected from rice, corn, rye or tapioca.

Flour compositions that include transglutaminase and lysine have been found to be more capable of absorbing water. In one embodiment, the composition is capable of absorbing at least about 56% by weight water and, in another embodiment, at least about 60% by weight water.

The flour composition may suitably be packaged according to any of the known methods within the art. In one embodiment, the wheat flour composition is hermetically sealed in a polymer bag. A plurality of bags may be shipped to end users such as, for example, in cardboard boxes.

### Methods for Producing Bread and Resulting Breads

One aspect of the present disclosure is directed to methods for producing bread products. Generally, the methods include mixing flour, transglutaminase, an amino acid selected from lysine, glutamine and a combination thereof, a leavening agent and water to make a dough and leavening the dough to produce a bread product. The amino acid and transglutaminase may be mixed into the dough contemporaneously or sequentially.

The flour, transglutaminase and the amino acid may be pre-mixed prior to mixing with the leavening agent and water. For instance, the flour, transglutaminase and the amino acid may be mixed according to the methods for producing a wheat flour composition as described above. The pre-mixing may take place at a wheat mill and mixing with a leavening agent, water and other optional ingredients may occur at a bakery. In one particular embodiment, the amino acid, transglutaminase and flour are mixed at a wheat mill to produce a supplemented flour product. The supplemented flour product is transported to a bakery. The supplemented flour product, leavening agent and water are mixed at the bakery to produce the bread product. The supplemented flour product may be transported to the bakery in a bag, truck or railcar.

In one embodiment, the amount of lysine mixed to form the dough is at least about 50 parts per million parts of flour mixed to make the dough. In various other embodiments, the amount of lysine mixed to form the dough by weight is at least about 100 parts per million parts of flour, from about 50 to about 1000 parts per million parts of flour or from about 100 to about 750 parts per million parts of flour. The lysine mixed to form the dough may be dissolved in the water to form the dough or may be particulate lysine. The average nominal diameter of the particulate lysine may be less than about 250 μm, less than about 125 μm or from about 5 μm to about 125 μm. In some embodiments, the particulate lysine is ground prior to mixing to form the dough.

Alternatively or in addition, glutamine may be mixed to form the dough. In one embodiment, the amount of glutamine mixed to form the dough is at least about 25 parts per million parts flour mixed to form the dough. In several other embodiments, the amount of glutamine mixed to form the dough by weight is at least about 50 parts per million parts of flour, from about 25 parts to about 500 parts per million parts of flour or from 50 to 400 parts per million parts of flour. The glutamine may be a particulate with the average nominal diameter of the particulates being less than about 250 μm by weight. In other embodiments, the average nominal diameter of the particulate glutamine is less than about 125 μm by weight or from about 5 μm by weight to about 125 μm by weight.

The amount of transglutaminase mixed to form the dough may be at least about 1 part per million parts of flour added by weight. In other embodiments, the amount of transglutaminase mixed to form the dough is at least about 15 parts per million parts of flour by weight, at least about 30 parts per million parts of flour by weight, from about 1 to about 500 parts per million parts of flour by weight, from about 15 to about 500 parts per million parts of flour by weight or from about 30 to about 300 parts per million parts of flour by weight. In some embodiments, the mass ratio of lysine to transglutaminase mixed to form the dough is at least about 1:1, at least about 2:1, at least about 3:1 or from about 1:1 to about 5:1. Alternatively or in addition, the mass ratio of glutamine to transglutaminase mixed to form the dough is at least about 1:2, at least about 1:1, at least about 2:1 or from about 1:2 to about 3:1. Additives such as enzymes and/or oxidation compounds may also be added to the dough.

The flour may be a low-protein flour. In various embodiments, the flour may contain less than about 10% by weight protein, less than about 9.5% by weight protein, less than about 9% by weight protein, less than about 8.5% by weight protein, from about 5% to about 10% by weight protein, from about 7.5% to about 10% by weight protein or from about 5% to about 9.5% by weight protein. The flour may be derived from wheat varieties containing low protein amounts such as soft white winter wheat or soft red winter wheat. The flour may also be a product flour that typically contains less protein such as whole-grain flours and high-extraction flours.

Addition of transglutaminase and lysine generally enhances the properties of the dough and the resulting bread such that, in some embodiments, vital wheat gluten is not added to the dough or the amount of vital wheat gluten added is reduced. Alternatively or in addition, mixing in transglutaminase and lysine, in some embodiments, allows the volume of the bread product to be at least the volume that could be achieved by producing a bread product under substantially the same conditions from a dough comprising flour derived from hard red winter wheat with no transglutaminase or lysine added thereto. In another embodiment, the volume of the bread product is at least the volume that could be achieved by producing a bread product under substantially the same conditions from a dough comprising flour with at least about 10.5% by weight protein with no transglutaminase or lysine added thereto. By addition of glutamine, these properties may be further enhanced.

The bread may be leavened according to any of the known methods including, for example, by adding yeast and heating to a temperature of at least about 85° F. (about 29° C.). In other embodiments, the bread is leavened by adding baking powder or baking soda and heating to a temperature of at least about 85° F. (about 29° C.).

The flour may be a wheat flour and other flours may be included with or substituted for wheat flour. For instance, the flour may include wheat flour and a cereal grain flour other than wheat flour. Suitable cereal grain flours include rice, corn, rye, tapioca flours and mixtures thereof. In one embodiment, the flour consists essentially of a flour derived from a cereal grain selected from rice, corn, rye and tapioca.

Because the flour composition includes transglutaminase and lysine, the dough is better able to absorb water. In one embodiment, the dough contains at least about 56% by weight water and, in another embodiment, at least about 60% by weight water.

Generally, inclusion of transglutaminase and lysine allows low-protein flours to produce high-quality breads. For instance, transglutaminase and lysine allow low-protein flours to produce breads with a volume at least as great as breads produced from high-protein flours. In one aspect of the present disclosure, a bread contains less than about 10% by weight protein and has a volume to weight ratio of at least about 9:2 and, in another embodiment, at least about 11:2.

In further embodiments, the bread contains less than about 9.5% by weight protein, less than about 9% by weight protein, less than about 8.5% by weight protein, from about 5% to about 10% by weight protein, from about 7.5% to about 10% by weight protein or from about 5% to about 9.5% by weight protein. In some embodiments, inclusion of transglutaminase and lysine in the low-protein flour allows the flour to be made into a bread without inclusion of vital wheat gluten.

In some embodiments, the volume of the bread product is at least the volume that could be achieved by producing a bread under substantially the same production conditions from a dough comprising flour derived from hard red winter wheat with no transglutaminase or lysine added thereto. In another embodiment, the volume of the bread product is at least the volume that could be achieved by producing a bread product under substantially the same production conditions from a dough comprising flour with at least about 10.5% by weight protein content with no transglutaminase or lysine added thereto. The phrase “substantially the same production conditions” is meant to include, for example, use of the same amount of ingredients other than transglutaminase and lysine and use of substantially the same kneading and baking procedures. In another embodiment, the bread contains a reduced amount of vital wheat gluten (e.g., less than about 5% or 4% by weight or even no wheat gluten) and the volume of the bread product is at least the volume that could be achieved by producing a bread product under substantially the same production conditions from a dough comprising flour with at least about 5% by weight vital wheat gluten with no transglutaminase or lysine added thereto.

### Methods for Producing Pasta Noodles

In one aspect of the present disclosure, a method for producing a noodle product comprises mixing flour, transglutaminase, an amino acid selected from lysine, glutamine and a combination thereof and water to make a dough. The dough may then be shaped into a noodle product. The noodle product may be dried to enhance the shelf-life of the noodle product. The amino acid and transglutaminase may be mixed into the dough contemporaneously or sequentially.

The flour, transglutaminase and amino acid may be pre-mixed prior to mixing with water. For instance, the flour, transglutaminase and amino acid may be mixed according to the methods for producing a wheat flour composition as described above. The pre-mixing may take place at a wheat mill and mixing with water and other optional ingredients may occur at a pasta noodle production facility. In one particular embodiment, the amino acid, transglutaminase and flour are mixed at a flour mill to produce a supplemented flour product. The supplemented flour product is transported to a production plant. The supplemented flour product, water and other optional ingredients are mixed at the production plant to produce the noodle product. The supplemented flour product may be transported to the production plant in a bag, truck or railcar.

In one embodiment, the amount of lysine mixed to form the dough is at least about 50 parts per million parts of flour mixed to make the dough by weight. In various other embodiments, the amount of lysine mixed to form the dough by weight is at least about 100 parts per million parts of flour, from about 50 to about 1000 parts per million parts of flour or from about 100 to about 750 parts per million parts of flour. The lysine mixed to form the dough may be dissolved in the water to form the dough or may be particulate lysine. The average nominal diameter of the particulate lysine may be less than about 250 μm, less than about 125 μm or from about 5 μm to about 125 μm. In some embodiments, the particulate lysine is ground prior to mixing to form the dough.

Alternatively or in addition, glutamine may be mixed to form the dough. In one embodiment, the amount of glutamine mixed to form the dough is at least about 25 parts per million parts flour mixed to form the dough. In several other embodiments, the amount of glutamine mixed to form the dough by weight is at least about 50 parts per million parts of flour, from about 25 parts to about 500 parts per million parts of flour or from 50 to 400 parts per million parts of flour. The glutamine may be a particulate with the average nominal diameter of the particulates being less than about 250 μm by weight. In other embodiments, the average nominal diameter of the particulate glutamine is less than about 125 μm by weight or from about 5 μm by weight to about 125 μm by weight.

The amount of transglutaminase mixed to form the dough may be at least about 1 part per million parts of flour added by weight. In other embodiments, the amount of transglutaminase mixed by weight to form the dough is at least about 15 parts per million parts of flour, at least about 30 parts per million parts of flour, from about 1 part per million parts of flour to about 500 parts per million parts of flour, from about 15 parts per million parts of flour to about 500 parts per million parts of flour or from about 30 parts per million parts of flour to about 300 parts per million parts of flour. In some embodiments, the mass ratio of lysine to transglutaminase mixed to form the dough is at least about 1:1, at least about 2:1, at least about 3:1 or from about 1:1 to about 5:1. Alternatively or in addition, the mass ratio of glutamine to transglutaminase mixed to form the dough is at least about 1:2, at least about 1:1, at least about 2:1 or from about 1:2 to about 3:1. Additives such as enzymes and/or oxidation compounds may also be added to the dough.

The flour utilized to form the dough may be a low-protein flour. In various embodiments, the flour may contain less than about 10% by weight protein, less than about 9.5% by weight protein, less than about 9% by weight protein, less than about 8.5% by weight protein, from about 5% to about 10% by weight protein, from about 7.5% to about 10% by weight protein or from about 5% to about 9.5% by weight protein. The flour may be derived from wheat varieties containing low protein amounts such as soft white winter wheat or soft red winter wheat. The flour may also be a product flour that typically contains less protein such as whole-grain flours and high-extraction flours.

Because the flour composition includes transglutaminase and lysine, the dough is more able to absorb water. In one embodiment, the dough contains at least about 56% by weight water and, in another embodiment, at least about 60% by weight water. By adding transglutaminase, lysine and glutamine to the flour compositions, resulting noodle products are characterized by greater elasticity relative to products produced by adding lysine and transglutaminase alone.

### EXAMPLES

### Example 1

### Comparison of Loaf Volume of Breads Formed from Dough Compositions Containing Transglutaminase and Lysine and/or Glutamine as a Replacement for Vital Wheat Gluten

Various dough compositions were prepared to determine the effect of adding transglutaminase, lysine and glutamine on loaf volume. The dough compositions were prepared by forming an initial sponge of material and mixing the sponge and other ingredients to form a dough. The components of the sponge and dough used to form the control loaf are shown as a baker's percentage (based on the amount of flour in the final dough) and a formulation percentage (based on the final dough) in Table 1 below. The ingredients under “dough” in Table 1 were added in addition to the sponge material.

TABLE 1
Percent inclusion of various ingredients added to form
sponge and dough material according to Example 1.

| | WEIGHT | BAKER'S | FORMULATION |
|---|---|---|---|
| INGREDIENT | (g) | (%) | (%) |
| SPONGE | | | |
| FLOUR | 700 | 70.00 | 41.56 |
| YEAST (INSTANT) | 10 | 1.00 | 0.59 |
| SALT | 2.5 | 0.25 | 0.15 |
| DATEM | 2 | 0.20 | 0.12 |
| SSL | 5 | 0.50 | 0.30 |
| CALCIUM | 2.5 | 0.25 | 0.15 |
| SULFATE | | | |
| WATER | 420 | 42.00 | 24.93 |
| DOUGH | | | |
| FLOUR | 300 | 30.00 | 17.81 |
| SUGAR | 40 | 4.00 | 2.37 |
| YEAST (INSTANT) | 7.5 | 0.75 | 0.45 |
| SALT | 17.5 | 1.75 | 1.04 |
| CALCIUM | 2.5 | 0.25 | 0.15 |
| PROPIONATE | | | |
| SHORTENING | 30 | 3.00 | 1.78 |
| (ALL PURP) | | | |
| GMS 90 (MONOS | 5 | 0.50 | 0.30 |
| & DIs) | | | |
| WATER | 140 | 14.00 | 8.31 |

The total amounts of ingredients (based on the final dough) are shown in Table 2 below.

TABLE 2
Percent inclusion of various ingredients relative to the final dough.

| INGREDIENT | WEIGHT | BAKER'S | FORMULATION |
|---|---|---|---|
| SPONGE | (g) | (%) | (%) |
| FLOUR | 1000 | 100.00 | 0.594 |
| YEAST (INSTANT) | 17.5 | 1.75 | 0.014 |
| SALT | 20 | 2.00 | 0.012 |
| DATEM | 2 | 0.20 | 0.001 |
| SSL | 5 | 0.50 | 0.003 |
| CALCIUM | 2.5 | 0.25 | 0.001 |
| SULFATE | | | |
| WATER | 560 | 56.00 | 0.332 |
| SUGAR | 40 | 4.00 | 0.024 |
| CALCIUM | 2.5 | 0.25 | 0.001 |
| PROPIONATE | | | |
| SHORTENING | 30 | 3.00 | 0.018 |
| (ALL PURP) | | | |
| GMS 90 ® (MONOS | 5 | 0.50 | 0.003 |
| & DIs) | | | |

In this regard, the following abbreviations were used in Tables 1 and 2: Datem—diacetyl tartaric acid esters of mono and diglycerides, SSL—sodium stearoyl lactylate, GMS 90—glycerol monostearate. Datem, SSL and GMS 90® each act as emulsifiers in the flour composition and calcium sulfate was added to enrich the bread. Calcium propionate was added as a preservative.

The sponge was prepared by mixing all of the sponge ingredients. The temperature of the sponge was controlled such that the final dough temperature was about 79-80° F. (˜26° C.). The sponge was allowed to ferment for three hours. The final dough was prepared by mixing all the dough ingredients (other than sponge). The sponge was then added in four pieces and the dough composition was mixed. The temperature of the final dough was controlled such that the final dough temperature was about 79-80° F. (˜26° C.). The fully mixed dough was allowed to rest for 20 minutes while covered. The dough was divided into pieces (539 g) and each piece was allowed to rest 10 minutes while covered. The dough was straight grain molded and allowed to rise before baking at 110° F. (43° C.). The dough was then baked for 22 minutes at 420° F. (216° C.).

In addition to the control loaf, several loaves were prepared with various amounts of vital wheat gluten (4 wt %, 5 wt % and 6 wt % (bakers %—i.e., relative to flour only)) and ascorbic acid (100 parts per million parts of flour) and several other loaves were prepared with various amounts of transglutaminase, lysine and/or glutamine (expressed as parts per million parts of flour in Table 3 below).

The flour used in the various dough compositions was a whole wheat flour with a protein content of about 11.5% (which is comparable to a white flour protein content of less than about 10%).

Finished loaves were sliced and evaluated by use of a C Cell analyzer (Calibre Control International (UK)). The volume of six slices from each loaf were averaged. The C Cell generated volume and standard deviations are relative units. The relative unit volumes and additives for each loaf are shown in Table 3 below with the loaves being ranked from largest volume to smallest volume (control).

TABLE 3
Loaf volume and additive amounts for various loaves prepared
in accordance with Example 1.

| Vital | | | | | | |
|---|---|---|---|---|---|---|
| Wheat | Ascorbic | Transglu- | | | | |
| Gluten | Acid | taminase | Lysine | Glutamine | | Std. |
| (%) | (ppm) | (ppm) | (ppm) | (ppm) | Volume | Dev. |
| 6 | 100 | — | — | — | 10370 | 304 |
| — | — | 200 | 600 | — | 9917 | 104 |
| — | — | 150 | 450 | — | 9907 | 183 |
| — | — | 200 | 800 | 400 | 9896 | 141 |
| — | — | 200 | 800 | — | 9749 | 123 |
| — | — | 150 | 300 | 150 | 9707 | 170 |
| — | — | 150 | 600 | — | 9687 | 232 |
| — | — | 150 | 300 | — | 9510 | 153 |
| — | — | 150 | 450 | 225 | 9476 | 203 |
| — | — | 200 | 600 | 300 | 9458 | 179 |
| 4 | 100 | — | — | — | 9365 | 344 |
| — | — | 150 | 750 | — | 9318 | 302 |
| 5 | 100 | — | — | — | 9299 | 161 |
| — | — | 200 | 1000 | 500 | 9232 | 239 |
| — | — | 150 | 600 | 300 | 9199 | 272 |
| — | — | 150 | 750 | 375 | 9185 | 197 |
| — | — | 200 | 400 | 200 | 8925 | 248 |
| — | — | — | — | — | 8253 | 715 |

As can be seen from Table 3, various combinations of transglutaminase, lysine and optionally glutamine were able to achieve loaf volume similar to the volume of loaves containing vital wheat gluten. The breads containing lysine and transglutaminase had a volume:weight ratio of about 9:2.

### Example 2

### Comparison of the Texture of Pasta prepared from Control Dough Compositions and Dough Compositions Containing Transglutaminase and Lysine and Glutamine

Several control pastas were prepared from dough compositions containing different types of wheat flour and different protein amounts. Amounts of transglutaminase, lysine and glutamine were added to the controls to determine the effect on pasta texture. The pasta texture was evaluated by a “texture analyzer” that records the pressure required to break a pasta strand. The results are shown in Table 4 below. The amounts of transglutaminase, lysine and glutamine are expressed as parts per million parts of flour.

TABLE 4
Types of flour, amounts of additives and texture of pastas prepared according to Example 2.

| | Dark | | Dark Northern | Soft | | | | | | |
|---|---|---|---|---|---|---|---|---|---|---|
| Hard Red | Northern | Durum | Spring Whole | White | Protein | Transglutaminase | Lysine | Glutamine | | Texture |
| Winter (%) | Spring (%) | (%) | Wheat (%) | Winter | (%) | (ppm) | (ppm) | (ppm) | Shape | (g-cm) |
| 100 | | | | | 10.5 | — | — | — | Short rotini | 116 |
| 100 | | | | | 10.5 | 200 | 600 | 300 | Short rotini | 127 |
| | 100 | | | | 12.5 | — | — | — | Short rotini | 121 |
| | 100 | | | | 12.5 | 200 | 600 | 300 | Short rotini | 146 |
| | | 100 | | | 13 | — | — | — | Short rotini | 126 |
| | | 100 | | | 13 | 200 | 600 | 300 | Short rotini | 155 |
| | | | 100 | | 13.5 | — | — | — | Short rotini | 107 |
| | | | 100 | | 13.5 | 200 | 600 | 300 | Short rotini | 137 |
| 50 | 50 | | | | 11.5 | — | — | — | Short elbow | 49 |
| 100 | | | | | 10.5 | — | — | — | Short elbow | 42 |
| 100 | | | | | 10.5 | 200 | 600 | — | Short elbow | 49 |
| 50 | | | | 50 | 9.5 | — | — | — | Short elbow | 38 |
| 50 | | | | 50 | 9.5 | 200 | 600 | — | Short elbow | 43 |

As can be seen from Table 4, addition of transglutaminase lysine and optionally glutamine resulted in a significant increase in the pasta texture.

### Example 3

### Comparison of the Texture of Pasta prepared from Dough Compositions Containing Different Amounts of Egg Albumin, Transglutaminase, Lysine and Glutamine

Durum wheat flour (13% protein) and egg albumin (shown as a baker's % in Table 5 below) were used to prepare pasta in a short elbow shape. In compositions containing less amounts of egg albumin, transglutaminase, lysine and glutamine were added to determine if the additives were effective in replacing egg albumin. The texture for each composition is shown in Table 5 below.

TABLE 5
Amounts of additives and texture of pastas
prepared according to Example 3.

| Egg | Transglutaminase | Lysine | Glutamine | Texture |
|---|---|---|---|---|
| Albumin (%) | (ppm) | (ppm) | (ppm) | (g-cm) |
| — | — | — | — | 30.5 |
| 2 | — | — | — | 32.5 |
| 1 | — | — | — | 31.5 |
| 1 | 250 | 650 | 300 | 33.1 |

As can be seen from Table 5, the dough composition having low amounts of albumin (1%) and supplemented with transglutaminase, lysine and glutamine was characterized by the best texture.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above apparatus and methods without departing from the scope of the disclosure, it is intended that all matter contained in the above description and shown in the accompanying figures shall be interpreted as illustrative and not in a limiting sense.

What is claimed is:

1. A method for preparing a wheat flour composition, the method comprising:
grinding wheat kernels to produce fragmented wheat particles;
separating flour from larger wheat particles; and
adding transglutaminase and an amino acid selected from the group consisting of lysine, glutamine and a combination thereof to the flour to produce a wheat flour composition.

2. A method as set forth in claim 1 comprising contacting the wheat kernels with water prior to grinding to temper the wheat, the water not containing transglutaminase.

3. A method as set forth in claim 1 wherein lysine is added until the wheat flour composition comprises at least about 50 ppm by weight lysine.

4. A method as set forth in claim 1 comprising grinding the particulate lysine to reduce the average nominal diameter of the particulate lysine before addition to the flour.

5. A method as set forth in claim 1 wherein transglutaminase is added until the wheat flour composition comprises at least about 1 ppm by weight transglutaminase.

6. A method as set forth in claim 1 wherein the mass ratio of lysine to transglutaminase added to the flour is at least about 1:1.

7. A method as set forth in claim 1 wherein the flour is a low-protein flour.

8. A method as set forth in claim 1 wherein the flour contains less than about 10% by weight protein.

9. A method as set forth in claim 1 wherein the amino acid and transglutaminase are contemporaneously added to the flour.

10. A method as set forth in claim 1 wherein the wheat flour composition is capable of absorbing at least about 56% by weight water.

11. A method as set forth in claim 1 wherein glutamine is added until the wheat flour composition comprises at least about 25 ppm by weight glutamine.

12. A supplement composition that may be added to flour to enhance a property of a resulting flour-based product, the composition comprising an amino acid selected from the group consisting of lysine, glutamine and a combination thereof and transglutaminase.

13. A supplement composition as set forth in claim 12 comprising at least about 20% by weight amino acid.

14. A supplement composition as set forth in claim 12 comprising at least about 1% by weight transglutaminase.

15. A supplement composition as set forth in claim 12 wherein the mass ratio of lysine to transglutaminase in the composition is at least about 1:1.

16. A method for producing a bread product, the method comprising:
mixing flour, transglutaminase, an amino acid selected from the group consisting of lysine, glutamine and a combination thereof, a leavening agent and water to make a dough; and
leavening the dough to produce a bread product.

17. A method as set forth in claim 16 wherein flour, transglutaminase and amino acid are pre-mixed prior to mixing with the leavening agent and water.

18. A method for producing a noodle product, the method comprising:
mixing flour, transglutaminase, an amino acid selected from the group consisting of lysine, glutamine, and a combination thereof and water to make a dough; and
shaping the dough into a noodle product.

19. A method as set forth in claim 18 wherein flour, transglutaminase and amino acid are pre-mixed prior to mixing with the water.

20. A bread containing less than about 10% by weight protein and having a volume to weight ratio of at least about 9:2.

21. A bread containing less than about 10% by weight protein and having a volume at least the volume that could be achieved by producing a bread product under substantially the same production conditions from a dough comprising flour with at least a 10.5% by weight protein content with no transglutaminase or lysine added thereto.

22. A bread containing less than about 10% by weight protein and less than about 5% by weight vital wheat gluten and having a volume at least the volume that could be achieved by producing a bread product under substantially the same production conditions from a dough comprising flour with at least about 5% by weight vital wheat gluten with no transglutaminase or lysine added thereto.

23. A bread as set forth in claim 22 wherein the bread does not contain vital wheat gluten.

24. A flour composition comprising flour, at least about 25 ppm amino acid selected from the group consisting of lysine, glutamine and a combination thereof and at least about 1 ppm transglutaminase.

25. A flour composition as set forth in claim 24 wherein the flour is a low-protein flour.

26. A flour composition as set forth in claim 24 wherein the flour composition is capable of absorbing at least about 56% water.
